(19) United States
(12) Patent Application Publication
(10) Pub. No.: US 2026/0298187 A1
(43) Pub. Date: Oct. 1, 2026

(54) FUEL PUMP

(71) Applicant: PHINIA DELPHI LUXEMBOURG SARL, Belvaux (LU)

(72) Inventors: Toby PEDLEY, London (GB); Erol KAHRAMAN, Maidstone (GB)

(21) Appl. No.: 19/477,237

(22) PCT Filed: Apr. 24, 2024
(86) PCT No.: PCT/EP2024/061305

§ 371 Date: Oct. 21, 2025

(30) Foreign Application Priority Data
Apr. 24, 2023 (GB) 2305986.8

(51) Int. Cl. F02M 59/02; F02M 59/46

(52) U.S. Cl. CPC F02M 59/025; F02M 59/46

(57) ABSTRACT

A fuel pump for a fuel injector of an internal combustion engine includes a housing provided with an axial bore and a piston slidably arranged in the bore. The bore defines a lower end through which the piston is received, an upper end opposite the lower end a side wall that extends between the lower and upper ends and a compression chamber located that incorporates the upper end of the bore The housing is provided with an inlet that opens into the compression chamber at the upper end of the bore and an outlet that opens into the compression chamber at a side wall of the bore The piston is configured to slide reciprocally between a lower position where fuel at low pressure enters the compression chamber via the inlet and an upper position where fuel in the compression chamber is pressurized before being expelled via the outlet. The piston includes a dilation region arranged at an upper end of the piston and a pressure relief region arranged below the dilation region The pressure relief region includes a pressure relief means and the dilation region includes a dilation means configured to dilate in response to a pressure differential between the compression chamber and the pressure relief region

### TECHNICAL FIELD

The present invention relates to a fuel pump and more particularly to a dilation arrangement of the piston of the pump.

### BACKGROUND OF THE INVENTION

High pressure fuel pumps known in the art have a housing provided with a bore defining a compression chamber and a cylindrical piston reciprocally translating within the bore so that fuel in the compression chamber is pressurized.

While the majority of the pressurized fuel exits via an outlet valve, a small quantity of pressurized fuel leaks through the functional clearance that is between the bore and the piston. In operation, when fuel is under high pressure, the clearance increases allowing more fuel leakage.

Fuel pumps 10 such as that shown in FIG. 1 are known in which an upper high-pressure extremity 14 of the piston 12 is provided with a recess 16 that receives high-pressure fuel. The recess 16 is surrounded by a peripheral wall 20. The high-pressure fuel causes the end of the piston 12 to dilate, so that the peripheral wall 20 expands outwardly. This dilation limits the clearance between the piston 12 and the bore 18, which reduces leakage.

Such pistons 12 are commonly incorporated into heavy duty, oil lubricated pumps, as is the case in the fuel pump 10 of FIG. 1. In such pumps, the piston 12 has a high pressure extremity 14 and a low-pressure extremity 15, and the pumping chamber has a high pressure outlet bore 22 exiting from the top of the chamber, in the vicinity of the high pressure extremity of the piston. It is important that the recess 16 in the piston extends sufficiently far into the piston that the base of the recess 16 is below the lowest point of the high pressure outlet bore, even when the piston is at the top of the stroke. This ensures that the dilation region of the piston always extends below the outlet bore, so that the tight clearance can be maintained below the outlet bore at all times.

It is against this background that the invention has been devised.

### SUMMARY OF THE INVENTION

The invention resides in a fuel pump for a fuel injector of an internal combustion engine, the pump comprising a housing provided with an axial bore and a piston slidably arranged in the bore. The bore defines a lower end through which the piston is received, an upper end opposite the lower end, a side wall that extends between the lower and upper ends, and a compression chamber located that incorporates the upper end of the bore. The housing is provided with an inlet that opens into the compression chamber at the upper end of the bore, and an outlet that opens into the compression chamber at a side wall of the bore. The piston is configured to slide reciprocally between a lower position where fuel at low pressure enters the compression chamber via the inlet and an upper position where fuel in the compression chamber is pressurized before being expelled via the outlet. The piston comprises a dilation region arranged at an upper end of the piston, and a pressure relief region arranged below the dilation region. The pressure relief region comprises a pressure relief means, and the dilation region comprises a dilation means configured to dilate in response to a pressure differential between the compression chamber and the pressure relief region.

The dilation means may comprise a first recess in the upper end of the piston.

The first recess may be in fluid communication with the compression chamber when the piston is in the lower position. The first recess may also be in fluid communication with the compression chamber when the piston the upper position.

The first recess may be surrounded by a peripheral wall.

The piston may comprise an opening in the upper end of the piston that opens into the first recess. The recess may provide fluid communication with the compression chamber.

The pressure relief means may comprise a second recess in a side wall of the piston.

The second recess may be located such that, when the piston is in the lower position, the second recess is not in fluid communication with the compression chamber.

The second recess may be located below the first recess.

The second recess may be an annular recess that extends around a circumference of the piston.

The second recess may be located on the piston such that, when the piston is in the upper position, the second recess is in fluid communication with the compression chamber.

The second recess may be located on the piston such that, when the piston is in the upper position, the second recess is aligned with the outlet.

When the dilation means comprises a first recess in the upper end of the piston, the fuel pump may comprise a projection that projects into the compression chamber at an upper end of the bore to fill the recess in the upper end of the piston when the piston is in the upper position

The fuel pump may comprise an inlet valve, and the projection may be provided on a head of the inlet valve.

The bore may define a lower bore region located towards the lower end of the bore, and the piston may comprise a lower piston region located below the pressure relief region. The piston and the bore may be configured such that the lower piston region is received in the lower bore region with a tight fit.

The piston and the bore may be configured such that a clearance between the lower piston region and the lower bore region is less than 10 microns.

The fuel pump may be a fuel lubricated pump.

### BRIEF DESCRIPTION OF THE FIGURES

FIG. 1, which illustrates a known arrangement of a piston incorporated into an oil lubricated pump, has already been described above. Embodiments of the invention will now be described, by way of example only, with reference to the remaining drawings, in which:

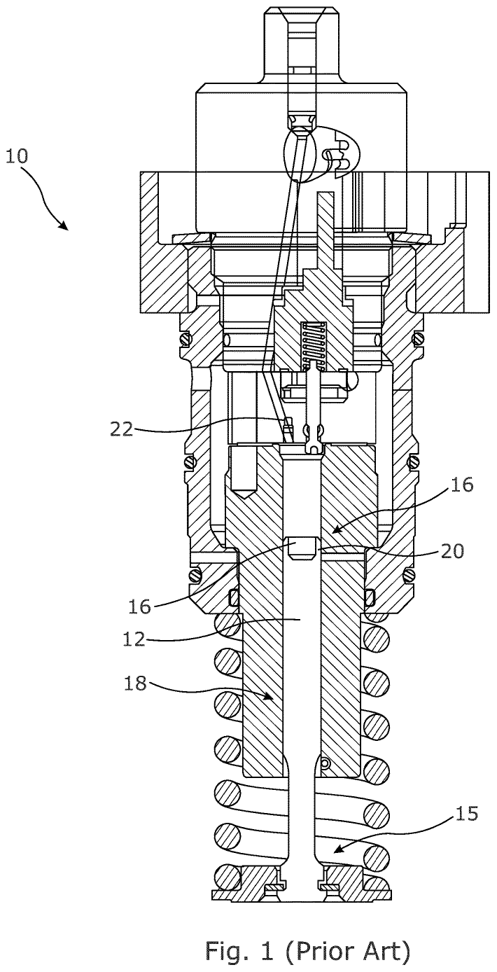

FIG. 2 is a cross section of a pump incorporating a piston according to an embodiment of the invention, in which the piston is in a lower position of the piston stroke; and

FIG. 3 is a cross section of the pump of FIG. 2, with the piston in an upper position of the piston stroke.

FIG. 4 is an enlarged partial view of FIG. 2.

In the drawings, as well as in the following description, like features are assigned like reference signs.

Throughout this description, terms such as ‘top’, ‘bottom’, ‘upper’ and ‘lower’, and other directional references, are used with reference to the orientation of the fuel pump as shown in the accompanying drawings. However, it will be appreciated that such references are not limiting and that fuel pumps according to the invention can be used in any orientation.

### DETAILED DESCRIPTION OF EMBODIMENTS OF THE INVENTION

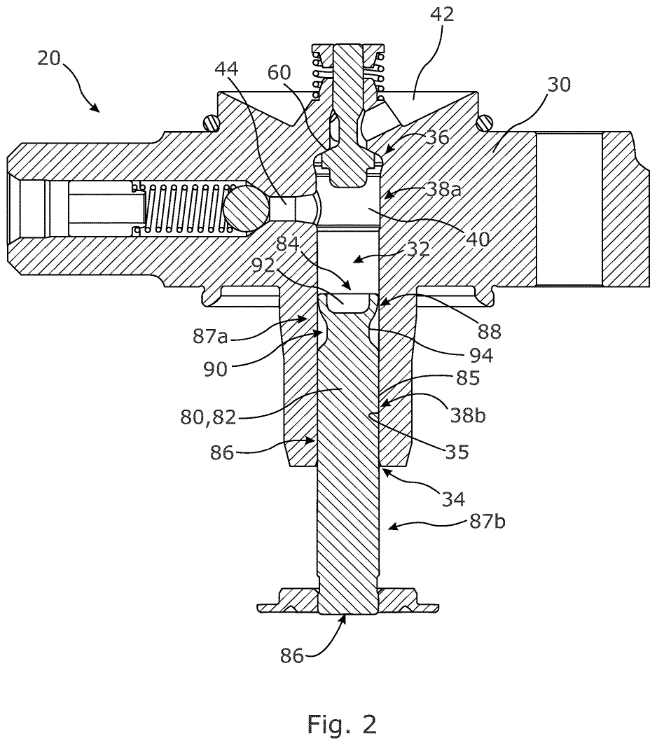

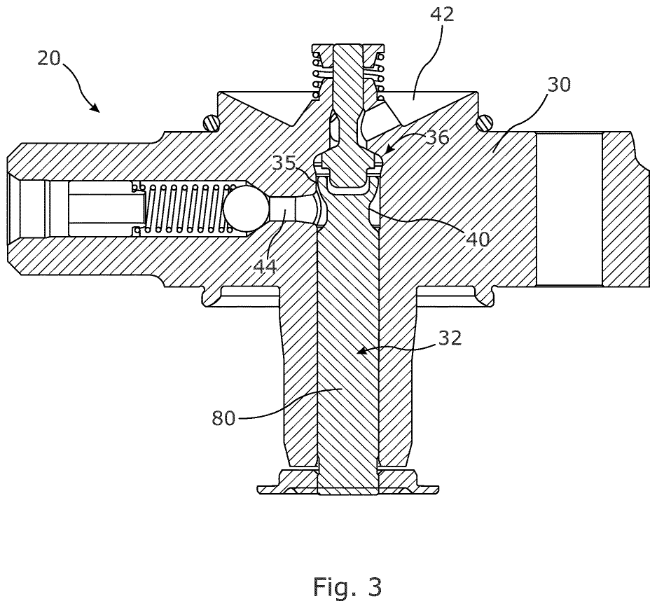

FIGS. 2 and 3 illustrate a fuel pump 20 according to an embodiment of the invention. The pump 20 is for a fuel injector of an internal combustion engine, and is a fuel-lubricated pump.

Referring to FIG. 2, the pump 20 comprises a housing 30 that defines an axial bore 32 therein. The bore 32 has a lower end 34, through which a piston 80 is received in the bore 32, and an upper end 36 that is opposite the lower end 34. A side wall 35 extends between the lower end 34 and the upper end 36. An upper region 38a of the bore 32 defines a compression chamber 40.

The piston 80 that is arranged for reciprocal movement within the bore 32 between a lower position, shown in FIG. 2 and an upper position, shown in FIG. 3. When the piston 80 is in the lower position, fuel enters the compression chamber 40 through an inlet 42 that opens into the compression chamber at the upper end 36 of the bore 32. As the piston 80 moves towards the upper position, the fuel is compressed. When the pressure is high enough, the high pressure fuel exits the compression chamber 40 via an outlet 44, which opens into the compression chamber 40 in the side wall 35 of the bore 32.

Referring still to FIG. 2, the piston 80 comprises an elongate body 82 having an upper end 84, and a lower end 86. A side wall 85 joins the upper and lower ends 84, 86. The side wall 85 defines a generally cylindrical surface.

An upper region 87a of the piston 80 incorporates the upper end 84 and adjacent part of the elongate body 82. The upper region 87a comprises a dilation region 88 that incorporates the upper end 84, and a pressure-relief region 90 below the dilation region 88.

The dilation region 88 incorporates a dilation means 92, exemplified here as a recess formed in the upper end 84 of the elongate body 82. The pressure-relief region 90 comprises a pressure-relief means 94, exemplified here as a circumferential recess formed in the side wall 85 of the elongate body 82.

In the dilation region 88, the piston 80 is a tight fit in the bore 32, for example with a clearance of 5 to 6 microns between the piston and the bore. In this way, the dilation means 92 and the pressure relief region 90 are isolated from each other, except for any fuel leakage that might occur from the compression chamber 40 down the bore 32. As fuel is pressurised in the compression chamber 40, the dilation region 88 is exposed to high pressure fuel. The pressure-relief region 90 is not exposed to this high pressure fuel, and the pressure-relief means 94 relieves pressure in the pressure-relief region 90, creating a pressure differential between the dilation region 88 and the pressure-relief region 90. This pressure differential causes the dilation means 92 to dilate, thereby increasing the diameter of the piston 80 in the dilation region 88. This reduces the clearance between the piston 80 and the side wall 35 of the bore 32, which reduces leakage from the compression chamber 40. Dilation of the dilation region 88 may for example reduce the clearance from 5 to 6 microns to less than 1 micron.

A lower region 87b of the piston 80 incorporates the lower end 86 and adjacent part of the elongate body 82. The lower region 87b is substantially cylindrical, and of substantially uniform cross section along its length.

The lower region 87b of the piston is housed in a lower region 38b of the bore 32. In the lower region 38b of the bore 32, the side wall 35 of the bore is substantially cylindrical. The lower region 87b of the piston 80 is configured to fit in the lower region 38b of the bore 32 with a close sliding fit, such that the clearance between the bore 32 and piston 80 is minimal in this region. For example the clearance may be less than 10 microns, and may be approximately 5 to 6 microns.

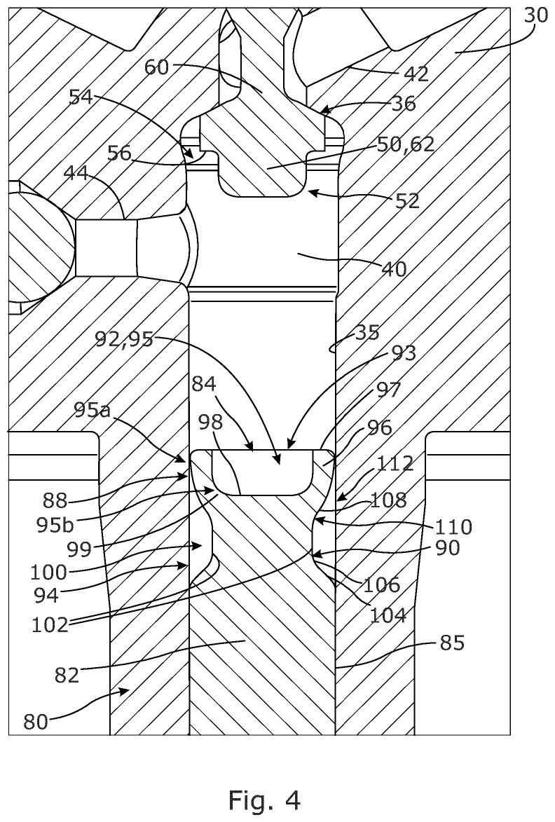

FIG. 4 illustrates the upper region 87a of the piston 80 and the bore 32 in more detail.

Considering the dilation region 88 in more detail, in this embodiment the dilation means 92 comprises a first recess or dilation recess 95 in the upper end 84 of the body 82 of the piston 80. More specifically, the first recess 95 opens on to the upper end 84 of the body 82 via an opening 93, but does not open onto side walls 85 of the body 82. The first recess 95 is surrounded by a peripheral wall 96, and an outer surface of the peripheral wall 96 defines part of the side wall 85 of the body 82.

The first recess 95 is substantially cylindrical for the majority of its height, and in particular is cylindrical in an upper region 95a that opens onto the upper end 84 of the body. In this region the recess 95 is therefore of uniform, circular cross section. The recess 95 is open at the upper end to define the opening 93 that allows fluid communication between the recess 95 and the compression chamber 40. Because the piston 80 is also substantially cylindrical in this region, with uniform, circular cross section, the peripheral wall 96 takes the form of an annular wall having substantially constant thickness for the majority of its height. An upper peripheral surface 97 of the peripheral wall 96 defines an upward-facing annular surface that surrounds the opening 93.

The first recess 95 may be of any size that is suitable to permit dilation of the dilation region. A depth of the first recess 95 is preferably between approximately 1 mm and 5 mm, and is most preferably less than 3 mm. This provides a balance between being sufficiently deep to allow the required dilation, but shallow enough to minimise the size of the recess and therefore maintain efficiency of the pump. The annular wall may be of any suitable thickness. For example a thickness of the wall 96 may be between approximately 0.7 mm and 1 mm.

At a base of the first recess 95, the peripheral wall 96 meets a base wall 98 of the first recess 95. The circumferential edge 99 where the peripheral wall 96 meets the base wall 98 is radiused, i.e. has a slight curvature, such that the diameter of the first recess 95 decreases slightly in a lower region 95b of the first recess 95 adjacent to the base wall 98.

Considering the pressure-relief region 90 in more detail, in this embodiment the pressure-relief means 94 comprises a second recess or pressure-relief recess 100 in the side wall 85 of the body 82. The second recess 100 is open to the side wall 85 of the body 82, and is not open to the upper end 84 of the body, or to the recess 95 that defines the dilation means 92. In this example, the second recess 100 is an annular or circumferential recess, such that it extends continuously around the circumference of the piston 80.

The second recess 100 defines a base wall 102, a lower side wall 104 and an upper side wall 108. The lower side wall 104 extends between a lower edge 106 of the base wall 102 and the side wall 85 of the body 82. In this example, the lower side wall 104 meets the base wall 102 at an obtuse angle, so that the lower side wall 104 slopes downwardly towards the side wall 85 of the body. The lower edge 108 where the lower side wall 104 meets the base wall 102 is radiused, i.e. has a slight curvature.

The upper side wall 108 extends between an upper edge 110 of the base wall 102 and the side wall 85 of the body 82. In this example, the upper side wall 108 meets the base wall 102 at an obtuse angle, so that the upper side wall 108 slopes upwardly towards the side wall 85 of the body. The upper edge 110 where the upper side wall 108 meets the base wall 102 is radiused, i.e. has a slight curvature. The upper side wall 108 of the second recess 100 leads to the dilation region 88 of the piston 80. In this way, the upper side wall 108 is continuous with the outer surface of the peripheral wall 96 that surrounds the first recess 95. A transition region 112 where the upper side wall 108 transitions into the peripheral wall 96 may be at a different angle to the base wall 102 than the remainder of the upper side wall 108, to provide a smooth transition.

The second recess 100 may be of any size that is suitable to permit relief of pressure and create a pressure differential between the pressure relief region 90 and the compression chamber 40.

As can be seen in FIG. 4, the second recess 100 that defines the pressure relief means 94 is located below the first recess 95 that defines the dilation means 92. In this particular example, there is a small degree of overlap in the vertical location of the second recess 100 and the first recess 95: i.e. the uppermost point of the second recess 100 is above the base wall 98 of the first recess 95. However, the majority of the second recess 100 is located below the base wall 98 of the first recess: and in particular, the base wall 102 of the second recess 100 is located below the base wall 98 of the first recess 95.

As best seen in FIG. 3, the second recess 100 is located on the piston 80 such that when the piston 80 is in the upper position, the second recess 100 is in communication with the compression chamber 40. This allows any fuel that has leaked into the second recess 100 to enter the compression chamber 40, and exit the compression chamber 40 via the outlet 44.

FIG. 4 also illustrates the compression chamber 40 in more detail.

The inlet 42 opens into the compression chamber 40 at an upper end 36 of the compression chamber 40. In this way, the inlet 42 is arranged opposite the first recess 95 in the piston 80. An inlet valve 60 is provided to control the flow of fuel through the inlet 42 into the compression chamber 40.

The pump is provided with a projection 50 that projects into the compression chamber 40 at the upper end 36 of the bore 32. A first portion 52 of the projection 50 is of substantially the same shape and dimensions as the first recess 95 in the upper end 84 of the piston 80. A second portion 54 of the projection defines a flange 56 that surrounds the top of the first portion 52. When the piston 80 is in its upper position, the projection 50 projects through the opening 93 of the first recess 95, and fills the first recess 95. The upper peripheral surface 97 of the peripheral wall 96 faces the flange of the second portion 54 with a small clearance.

The projection 50 may be a solid block, or it may be hollow, or of any other appropriate construction. In this example, the projection 50 is incorporated into the inlet valve 60, and defines a projection on the head 62 of the inlet valve 60.

The outlet 44 does not open into the upper end 36 of the compression chamber 40, but instead opens into the side wall 35 of the compression chamber 40. The outlet 44 is a horizontal outlet that meets the bore 40 at 90 degrees to a longitudinal axis of the bore 40. In this example, the outlet 44 is spaced a short distance downwardly from the upper end 36, such that a portion of the side wall 35 is located between the outlet 44 and the inlet 42. This arrangement is typical in a fuel-lubricated pump, and differs from the arrangement of an oil-lubricated pump, in which both the inlet 42 and outlet 44 would open into the upper end 36 of the bore 32.

The outlet 44 and the second recess 100 are located such that when the piston 80 is in its upper position, the second recess 100 is generally aligned with the outlet 44.

It is generally desirable for the first recess 95 to be as shallow as possible, whilst still providing the required dilation. The first recess 95 may be sufficiently shallow when the piston 80 is in its upper position, the base of the first recess 95 is located above the outlet 44. In particular, the base wall 98 of the first recess 95 is located above the upper most point where the outlet 44 opens into the side wall 35.

During operation of the pump 20, when the piston 80 is in the lower position, fuel enters the compression chamber 40 via the inlet 42. Fuel enters the first recess 95, but does not enter the second recess 100, because in this lower position the second recess 100 is not in fluid communication with the compression chamber 40.

As the piston 80 moves towards the upper position, as soon as the top of the piston 80 has moved past the outlet 44, the fuel is compressed and hence pressurised. The second recess 100 does not contain high-pressure fuel, and thus a pressure differential is created between the first recess 95 and the second recess 100. This pressure differential causes the first recess 95 to dilate, which causes the peripheral wall 96 to expand outwardly towards the side wall 35 of the bore 32. This reduces the clearance between the piston 80 and the side wall 35 of the bore 32 in the dilation region 88 of the piston 80, thereby reducing leakage of fuel out of the compression chamber 40 via the bore 32.

As the piston 80 moves upwards and the fuel is pressurised, fuel is ejected through the outlet 44. As the piston 80 approaches the upper position, the projection 50 on the valve head 62 begins to fill the first recess 95, thereby displacing any fuel in the first recess 95. When the piston 80 is at the top of the stroke, the projection 50 fills the recess 95 almost completely, so that substantially all the fuel is displaced from the recess 95, to ensure efficiency of the pump 20.

As the piston 80 moves downwardly again, fuel fills the pumping chamber 40 once again at lower pressure. At this low pressure there is no, or relatively little, dilation of the dilation region 88. Small amounts of fuel may leak from the compression chamber 40 through the bore 32 into the second recess 100 at this stage. However, further leakage down the bore 32 is prevented by the tight fit between the lower part of the piston 80 and the lower part of the bore 32. Any leaked fuel will therefore remain in the second recess 100, where it remains at low pressure.

As the piston 80 returns to the upper position once more, fuel in the compression chamber 40 and first recess 100 is once again compressed so that pressure increases. Any leaked fuel in the second recess 100 is not compressed, and therefore remains at low pressure, providing the same pressure differential. At the upper position, the second recess 100 aligns with the outlet 44, and any fuel in the second recess 100 may exit the second recess 100 via the outlet 44. Once the second recess 100 is in this position where it can communicate with the outlet valve bore 44, the tight fit between the lower part of the piston 80 and the lower part of the bore 32 prevents leakage to cambox of the pump, ensuring that there is leakage prevention through the entire stroke.

Over successive cycles, fuel may build up in the second recess 100, and pressure in the second recess 100 may increase to a limited extent. However, because the second recess 100 is in communication with the outlet 44 when the piston 80 is in the upper position, fuel will always exit the second recess 100 via the outlet 44, thereby allowing the fuel in the second recess 100 to return to a low pressure when the second recess 100 moves below the outlet 44. In this way, the pressure differential between the first recess 95 and the second recess 100 is maintained whenever the fuel in the first recess 95 is pressurised, and whenever the second recess 100 is below the outlet 44.

Throughout the operation of the pump 20, the close clearance between the lower region 87b of the piston 80 and the lower region 38b of the bore 32 prevents leakage of fuel into the cambox. The close clearance also allows the bore 32 to provide guidance and support to the piston 80 to counter side loads that are applied by the drivetrain during pumping.

Thus, the pump provides a tight clearance between the piston 80 and the bore 32 along the length of the piston 80. At the upper end, the clearance is reduced by the dilation of the piston 80 in the dilation region 88, which is caused by the pressure differential between pressure in the dilation region 88 compared to the pressure relief region 90. Any fuel that leaks into the pressure relief region is deposited back into the pumping chamber when the piston 80 is in the upper position. The pump thereby combines the benefits of an EPT piston with a standard piston.

1. A fuel pump for a fuel injector of an internal combustion engine, the pump comprising a housing provided with an axial bore and a piston slidably arranged in the bore;
the bore defining a lower end through which the piston is received, an upper end opposite the lower end, a side wall that extends between the lower and upper ends, and a compression chamber located that incorporates the upper end of the bore;
the housing being provided with an inlet that opens into the compression chamber at the upper end of the bore, and an outlet that opens into the compression chamber at a side wall of the bore;
the piston being configured to slide reciprocally between a lower position where fuel at low pressure enters the compression chamber via the inlet and an upper position where fuel in the compression chamber is pressurized before being expelled via the outlet;
wherein the piston comprises a dilation region arranged at an upper end of the piston, and a pressure relief region arranged below the dilation region;
and wherein the pressure relief region comprises a pressure relief means, and the dilation region comprises a dilation means configured to dilate in response to a pressure differential between the compression chamber and the pressure relief region.

2. The fuel pump of claim 1, wherein the dilation means comprises a first recess in the upper end of the piston.

3. The fuel pump of claim 2, wherein the first recess is surrounded by a peripheral wall.

4. The fuel pump of claim 2, wherein the piston comprises an opening in the upper end of the piston that opens into the first recess.

5. The fuel pump of claim 1, wherein the pressure relief means comprises a second recess in a side wall of the piston.

6. The fuel pump of claim 5, wherein the second recess is located such that, when the piston is in the lower position, the second recess is not in fluid communication with the compression chamber.

7. The fuel pump of claim 5, wherein the second recess is located below the first recess.

8. The fuel pump of claim 5, wherein the second recess is an annular recess that extends around a circumference of the piston.

9. The fuel pump of claim 8, wherein the second recess is located on the piston such that, when the piston is in the upper position, the second recess is in fluid communication with the compression chamber.

10. The fuel pump of claim 9, wherein the second recess is located on the piston such that, when the piston is in the upper position, the second recess is aligned with the outlet.

11. The fuel pump of claim 2, comprising a projection that projects into the compression chamber at an upper end of the bore to fill the recess in the upper end of the piston when the piston is in the upper position

12. The fuel pump of claim 11, wherein the fuel pump comprises an inlet valve, and the projection is provided on a head of the inlet valve.

13. The fuel pump of claim 1, wherein the bore defines a lower bore region located towards the lower end of the bore, and the piston comprises a lower piston region located below the pressure relief region, wherein the piston and the bore are configured such that the lower piston region is received in the lower bore region with a tight fit.

14. The fuel pump of claim 1, wherein the fuel pump is a fuel lubricated pump.
